(19) United States
(12) Patent Application Publication
(10) Pub. No.: US 2019/0091795 A1
(43) Pub. Date: Mar. 28, 2019

(54) WELDED PORTION FORMING STRUCTURE AND METAL MEMBER JOINING METHOD

(71) Applicant: HONDA MOTOR CO., LTD., TOKYO (JP)

(72) Inventors: Takahisa TASHIRO, HAGAGUN (JP); Hiroyuki NAGAI, HAGAGUN (JP); Takefumi YOKOYAMA, HAGAGUN (JP); Takeshi YAMAZAKI, HAGAGUN (JP)

(21) Appl. No.: 16/126,256

(22) Filed: Sep. 10, 2018

(30) Foreign Application Priority Data
Sep. 11, 2017 (JP) 2017-173677
Aug. 6, 2018 (JP) 2018-147757

(51) Int. Cl. B23K 11/30; B23K 11/00; B23K 11/093; F01L 3/22

(52) U.S. Cl. CPC B23K 11/3009; B23K 11/0033; B23K 2101/006; F01L 3/22; B23K 11/093

(57) ABSTRACT

A welded portion forming structure forms a welded portion that joins a valve seat and a cylinder head main body. If the distance in a radial direction between a vertex of a corner, which is formed by a first surface and a second surface of the convex portion, and the first origin portion is assumed to be A, and the distance in the radial direction between the vertex and the second origin portion is assumed to be B, then a relation that satisfies all of A>0, A≥B, and B≥0 holds. Moreover, an angle which a first joint surface of the valve seat forms with an axial direction and an angle which the second joint surface forms with the axial direction are equal.

### BACKGROUND OF THE INVENTION

### Field of the Invention

The present invention relates to a welded portion forming structure for forming a welded portion that joins a first metal member and a second metal member, and a metal member joining method of joining the first metal member and the second metal member by forming the welded portion from the welded portion forming structure.

### Description of the Related Art

For example, Japanese Laid-Open Patent Publication No. 09-079012 discloses forming a welded portion between a first metal member and a second metal member by resistance welding, without using methods such as press fitting whose shape design flexibility is low or laser cladding which allows only limited materials to be used and whose production efficiency is low. Specifically, the first metal member shaped like an annular ring is inserted into an insertion opening provided in the second metal member, and a flow of current is applied thereto with a first joint surface of the first metal member and a second joint surface of the second metal member being pressure welded. As a result, the welded portion that joins the first joint surface and the second joint surface is formed.

The shapes of the first metal member and the second metal member may vary at least within machining tolerances. If such variations in shape or the like cause the contact area between the first joint surface and the second joint surface to vary among the first metal members and second metal members, then the amounts of heat generation based on contact resistance also vary. This causes variations in the joint strength between the first metal member and the second metal member, which leads to fear that it becomes difficult to maintain good joint quality by the welded portion.

Thus, Japanese Laid-Open Patent Publication No. 09-079012 proposes providing a convex portion shaped like an annular ring in the second joint surface and bringing the vertex of the convex portion into line contact with the first joint surface. The patent publication states that even when the above-mentioned variations in shape occur, it is possible to easily maintain a constant contact area between the vertex of the convex portion and the first joint surface being in line contact, and whereby the occurrence of variations in the amount of heat generation based on contact resistance can be suppressed.

### SUMMARY OF THE INVENTION

Although the convex portion and the first joint surface make line contact with each other at the beginning of contact, when the convex portion melts as the resistance welding progresses, the melted surface of the convex portion and the first joint surface make surface contact with each other. Then, the resistance welding progresses concurrently with discharge of the melted convex portion from between the first joint surface and the second joint surface, and, finally, the first joint surface and the second joint surface make contact with each other and the welded portion is formed.

As described above, depending on the progress of resistance welding, the contact area between the convex portion and the first joint surface, for example, changes. For this reason, by just providing the convex portion in the second joint surface, it is sometimes impossible to maintain a state in which the first metal member and the second metal member are in good contact with each other and evenly heat the entire contact surface from the beginning to the end of the resistance welding. After all, it is impossible to address concerns about the occurrence of variations in the joint strength between the first metal member and the second metal member and it is still difficult to maintain good joint quality by the welded portion.

A main object of the present invention is to provide a welded portion forming structure that can form a welded portion which can join a first metal member and a second metal member satisfactorily.

Another object of the present invention is to provide a metal member joining method that can form a welded portion which can join a first metal member and a second metal member satisfactorily.

An embodiment of the present invention provides a welded portion forming structure for forming a welded portion that joins a first metal member shaped like an annular ring and a second metal member having an insertion opening into which the first metal member is inserted. The first metal member is inserted into the insertion opening from one end side to the other end side thereof in an axial direction. An outer periphery of the first metal member has a first joint surface having a taper shape whose diameter is increased from a front end side to a base end side of an insertion direction into the insertion opening. An inner periphery of the insertion opening has a convex portion, a first tapered surface, and a second tapered surface, the convex portion being shaped like an annular ring and protruding from a second joint surface which can form the welded portion with the first joint surface, the first tapered surface having a taper shape extending from a first origin portion of the second joint surface from which the convex portion rises on the one end side, to the one end side of the insertion opening, in a direction in which the diameter of the insertion opening is increased, the second tapered surface having a taper shape extending from a second origin portion of the second joint surface from which the convex portion rises on the other end side, to the other end side of the insertion opening, in a direction in which the diameter of the insertion opening is reduced. The convex portion has a first surface extending from the first origin portion to a center side of the insertion opening in a radial direction, and a second surface which extends from the second origin portion to an end of extension of the first surface and forms a corner with the first surface. If the distance in the radial direction between a vertex of the corner and the first origin portion is assumed to be A, and the distance in the radial direction between the vertex and the second origin portion is assumed to be B, then a relation that satisfies all of A>0, A≥B, and B≥0 holds. An angle which the first joint surface forms with an axial direction of the first metal member, and an angle which the second joint surface connecting the first origin portion and the second origin portion in the shortest distance forms with the axial direction of the insertion opening are equal.

In this welded portion forming structure, since the convex portion is provided in the second joint surface of the second metal member, it is possible to start resistance welding by energizing the first metal member and the second metal member while applying a pressure welding load thereto in a state in which the vertex of the convex portion is in line contact with the first joint surface. As a result, even when the shapes of the first metal member and the second metal member vary, it is possible to prevent variations in the contact area between the first metal member and the second metal member at the beginning of contact.

Moreover, in this welded portion forming structure, the shape of the convex portion is set so as to satisfy the above-described relation and settings are made so that an angle which the first joint surface forms with the axial direction of the first metal member and an angle which the second joint surface forms with the axial direction of the insertion opening are equal. As a result, even when resistance welding is conducted concurrently with melting of the convex portion, it is possible to avoid a contact surface center between the first metal member and the second metal member in the radial direction of the insertion opening from shifting to the center side in the radial direction from the original contact position between the vertex of the convex portion and the first joint surface until the first joint surface and the second joint surface make contact with each other. This makes it possible to prevent deformation from occurring in the first metal member by the pressure welding load at the time of resistance welding.

Thus, with this welded portion forming structure, irrespective of whether or not, for example, the shapes of the first metal member and the second metal member vary, it is possible to bring the first metal member and the second metal member into good contact with each other from the beginning to the end of resistance welding. Since this makes it possible to prevent variations in the joint strength between the first metal member and the second metal member, it is possible to maintain good joint quality by the welded portion. In other words, it is possible to form the welded portion that can join the first metal member and the second metal member satisfactorily.

In the above-described welded portion forming structure, it is preferable that, in an interior angle of the corner, if an angle formed by a reference line, which passes through the vertex of the corner in parallel with the axial direction of the insertion opening, and the first surface is assumed to be α, and an angle formed by the reference line and the second surface is assumed to be β, then a relation that satisfies all of α>0, α≥β, and β≥0 holds. Also in this welded portion forming structure, irrespective of whether or not, for example, the shapes of the first metal member and the second metal member vary, it is possible to bring the first metal member and the second metal member into good contact with each other from the beginning to the end of resistance welding. As a result, it is possible to form the welded portion that can join the first metal member and the second metal member satisfactorily.

Another embodiment of the present invention provides a welded portion forming structure for forming a welded portion that joins a first metal member shaped like an annular ring and a second metal member having an insertion opening into which the first metal member is inserted. The first metal member is inserted into the insertion opening from one end side to the other end side thereof in an axial direction. An outer periphery of the first metal member has a first joint surface with a part having a taper shape whose diameter is increased from a front end side to a base end side of an insertion direction into the insertion opening. An inner periphery of the insertion opening has a convex portion that is shaped like an annular ring and protrudes from a second joint surface which can form the welded portion with the first joint surface. The convex portion has a first surface extending from a first origin portion of the second joint surface from which the convex portion rises on the one end side, to a center side of the insertion opening in a radial direction, and a second surface which extends from a second origin portion of the second joint surface from which the convex portion rises on the other end side, to an extension end of the first surface, and forms a corner with the first surface. If the length of the first surface from the first origin portion to a vertex of the corner is assumed to be L1 and the length of the second surface from the second origin portion to the vertex is assumed to be L2 in a cross section along the axis of the insertion opening, a relation of 0.7×L2≤L1≤1.3×L2 holds.

In this welded portion forming structure, as a result of the convex portion being provided in the second joint surface of the second metal member, even when the shapes of the first metal member and the second metal member vary, it is possible to prevent variations in the contact area between the first metal member and the second metal member at the beginning of contact.

Moreover, in this welded portion forming structure, by setting the shape of the convex portion as described above, even when resistance welding is conducted concurrently with melting of the convex portion, it is possible to prevent the length (the energization distance) of the path of current from varying from part to part of the convex portion. This makes it possible to prevent a temperature difference from being generated in a contact surface between the first metal member and the second metal member during resistance welding.

Thus, with this welded portion forming structure, irrespective of whether or not, for example, the shapes of the first metal member and the second metal member vary, it is possible to heat the contact surface between the first metal member and the second metal member substantially evenly from the beginning to the end of resistance welding. As a result, it is possible to prevent variations in the joint strength between the first metal member and the second metal member and maintain good joint quality by the welded portion. In other words, it is possible to form the welded portion that can join the first metal member and the second metal member satisfactorily.

In the above-described welded portion forming structure, the L1 and the L2 may be substantially equal. In this case, it is possible to form the welded portion that can join the first metal member and the second metal member satisfactorily with a simple configuration.

In the above-described welded portion forming structure, it is preferable that, if an angle formed by the radial direction of the insertion opening and the surface direction of the first surface is assumed to be γ and an angle formed by the axial direction of the insertion opening and the surface direction of the second surface is assumed to be δ, then a relation of 0°<γ=δ<45° holds. In this case, it is possible to reduce the amount of the melted convex portion which is discharged from between the first joint surface and the second joint surface at the time of resistance welding. This makes it possible to reduce energy required to form the welded portion.

In the above-described welded portion forming structure, it is preferable that a direction in which an inner periphery of the first metal member extends in the axial direction of the first metal member, and a direction in which a base end face, which is an end face of the first metal member on the base end side, extends in a radial direction of the first metal member intersect at an intersection, an end of the inner periphery of the first metal member on the base end side coincides with the intersection or is away from the intersection to the front end side of the first metal member, an end of the base end face on a center side of the first metal member in the radial direction coincides with the intersection or is away from the intersection to an outer side of the first metal member in the radial direction, and, if the distance between an end of the inner periphery of the first metal member on the front end side and the intersection is assumed to be a, the distance between an end of the base end face on the outer side of the first metal member in the radial direction and the intersection is assumed to be b, and the distance between the end of the base end face on the center side of the first metal member in the radial direction and the intersection is assumed to be c, then a relation that satisfies all of b/a≥1 and b/3≥c≥0 holds.

In this case, since the stiffness of the first metal member against the pressure welding load can be satisfactorily increased, it is possible to more effectively prevent the first metal member from being deformed at the time of resistance welding. As a result, since it is possible to conduct resistance welding while maintaining good contact between the first metal member and the second metal member, the joint quality which is obtained by the welded portion can be further improved.

In the above-described welded portion forming structure, it is preferable that the first metal member is formed of an iron-based material and the second metal member is formed of an aluminum-based material. For instance, in a structure that forms the welded portion by overlaying the first metal member on the second joint surface by a laser cladding process, there are severe restrictions on materials which can be applied as the first metal member and the second metal member. However, in the welded portion forming structure according to the present invention, since it is possible to use, as the first metal member and the second metal member, various materials on which resistance welding can be performed, it is possible to form the welded portion satisfactorily even when the first metal member is formed of iron-based material and the second metal member is formed of aluminum-based material. By using iron-based material, it is possible to, for example, increase the wear resistance of the first metal member, and, by using aluminum-based material, it is possible to, for example, reduce the weight of the second metal member.

In the above-described welded portion forming structure, it is preferable that the first metal member is a valve seat, the second metal member is a cylinder head main body, and the insertion opening is an opening circumferential portion of a port provided in the cylinder head main body. With this welded portion forming structure, it is possible to join the first joint surface of the valve seat and the second joint surface of the cylinder head main body by forming the welded portion by resistance welding. As a result, unlike in a case where the valve seat and the cylinder head main body are joined by press fitting, shrinkage fit, or the like, it is possible to achieve sufficient joint strength in a small fixed space. That is, since the thickness of the valve seat can be reduced, it is possible to enhance flexibility of the shape of the port and increase cooling efficiency of a valve and so forth by shortening the distance between a valve contact surface of the valve seat and a cooling jacket.

Still another embodiment of the present invention provides a metal member joining method of joining the first metal member and the second metal member by forming the welded portion from the above-described welded portion forming structure. The metal member joining method includes: a step of bringing the vertex of the corner into contact with the first joint surface; and a step of energizing the first metal member and the second metal member while applying a pressure welding load thereto, so as to bring the first metal member and the second metal member close to each other while discharging the convex portion, which is melted, from between the first joint surface and the second joint surface, and thus making the first joint surface and the second joint surface make contact with each other.

With this metal member joining method, irrespective of whether or not, for example, the shapes of the first metal member and the second metal member vary, it is possible to form the welded portion of high joint quality by heating the first metal member and the second metal member while maintaining good contact therebetween. As a result, it is possible to obtain a joined body by joining the first metal member and the second metal member satisfactorily.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a sectional view of a valve seat (a first metal member) and a cylinder head main body (a second metal member) of a welded portion forming structure according to a first embodiment of the present invention;

FIG. 2 is an enlarged view of principal portions of the valve seat of FIG. 1;

FIG. 3 is an enlarged view of principal portions of the cylinder head main body of FIG. 1;

FIG. 4 is a schematic sectional view of principal portions of a cylinder head obtained by applying the welded portion forming structure of FIG. 1;

FIG. 5 is an explanatory diagram explaining a state in which a first joint surface of the valve seat of FIG. 2 and a convex portion provided in a second joint surface of the cylinder head main body of FIG. 3 were brought into contact with each other;

FIG. 6 is an explanatory diagram explaining a state in which the valve seat and the cylinder head main body were brought close to each other by melting the convex portion of FIG. 5;

FIG. 7 is an explanatory diagram explaining a state in which a welded portion that joins the first joint surface and the second joint surface was formed by bringing the valve seat and the cylinder head main body of FIG. 6 closer to each other;

FIG. 8 is an explanatory diagram explaining the positions of a contact position P1 of FIG. 5, a contact surface center P2 of FIG. 6, and a contact surface center P3 of FIG. 7 in connection with the valve seat before the formation of the welded portion;

FIG. 9 is a graph showing the relationship between the amount of displacement of the contact surface center P2 from the contact position P1 in a radial direction and the amount of deformation of the first joint surface caused by a pressure welding load;

FIG. 10 is an enlarged view of principal portions of a valve seat according to a modified example of the first embodiment;

FIG. 11A is an enlarged view of principal portions of a cylinder head main body according to a modified example of the first embodiment;

FIG. 11B is an enlarged view of principal portions of a cylinder head main body according to another modified example;

FIG. 12 is a sectional view of a valve seat and a cylinder head main body of a welded portion forming structure according to a second embodiment of the present invention;

FIG. 13 is an enlarged view of principal portions of the cylinder head main body of FIG. 12;

FIG. 14 is an explanatory diagram explaining a state in which a convex portion provided in a second joint surface of the cylinder head main body was brought into contact with a first joint surface of the valve seat of FIG. 12;

FIG. 15 is an explanatory diagram explaining a state in which the valve seat and the cylinder head main body were brought close to each other by melting the convex portion of FIG. 14;

FIG. 16 is an explanatory diagram explaining a state in which a welded portion that joins the first joint surface and the second joint surface was formed by bringing the valve seat and the cylinder head main body of FIG. 15 closer to each other;

FIG. 17A is a graph showing the results of a displacement amount measurement test of Examples 1 and 2;

FIG. 17B is a graph showing the results of a joint strength measurement test of Examples 1 and 2;

FIG. 18A is a graph showing the results of the displacement amount measurement test of Examples 3 and 4;

FIG. 18B is a graph showing the results of the joint strength measurement test of Examples 3 and 4; and

FIG. 19 is a graph showing the results of the joint strength measurement test of Examples 5 and 6.

### DESCRIPTION OF THE PREFERRED EMBODIMENTS

Preferred embodiments of a welded portion forming structure and a metal member joining method according to the present invention will be described in detail with reference to the accompanying drawings. In the following drawings, component elements having the same or similar functions and effects will be identified with the same reference character and overlapping explanations will be omitted in some cases.

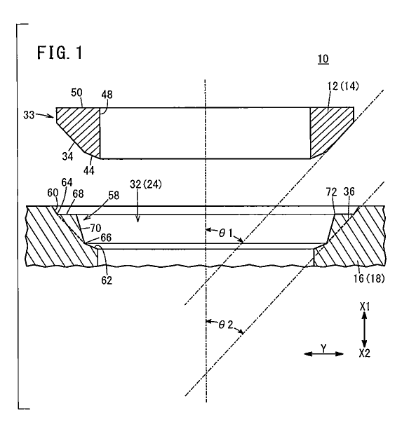

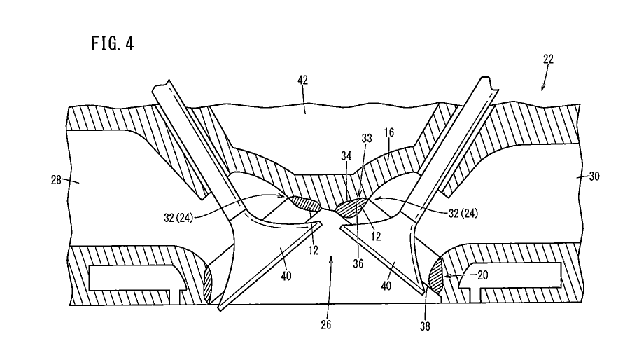

In the following description, as depicted in FIGS. 1 to 4, an example will be described in which a welded portion forming structure 10 according to a first embodiment is a structure for forming a welded portion 20 (see FIG. 4) that joins a first metal member 14 which is a valve seat 12 and a second metal member 18 which is a cylinder head main body 16. That is, the cylinder head 22 depicted in FIG. 4 is obtained by joining the valve seat 12 and the cylinder head main body 16 by forming the welded portion 20 from the welded portion forming structure 10 by a metal member joining method (hereinafter also referred to simply as the joining method) according to the first embodiment.

However, the first metal member 14 and the second metal member 18 to which the welded portion forming structure 10 according to the present invention can be applied are not limited to the valve seat 12 and the cylinder head main body 16. The welded portion forming structure 10 can be applied to any first metal member 14 and any second metal member 18, as long as they are a first metal member 14 shaped like an annular ring and a second metal member 18 having an insertion opening 24 into which the first metal member 14 is inserted and they are formed of materials on which resistance welding can be performed, as is the case in the valve seat 12 and the cylinder head main body 16.

First, with reference to FIG. 4, the cylinder head 22 including the valve seat 12 and the cylinder head main body 16 after the formation of the welded portion 20 will be described. The valve seat 12 is an annular body formed of a sintered body of an iron-based material such as steel, for example. The valve seat 12 may further contain a high-electric-conductivity material such as a copper-based material.

The cylinder head main body 16 is formed of an aluminum-based material such as pure aluminum or an aluminum alloy, for example. The cylinder head main body 16 has an intake port 28 and an exhaust port 30 (hereinafter, these ports will be also referred to collectively as the ports) each having an opening into a combustion chamber 26 on one end side thereof. Opening circumferential portions 32 of these ports are insertion openings 24, and the valve seat 12 is joined to the cylinder head main body 16 via the welded portion 20 in a state in which the valve seat 12 is inserted in each opening circumferential portion 32. Specifically, a first joint surface 34 provided in an outer periphery 33 of the valve seat 12 and a second joint surface 36 provided in an inner periphery of the opening circumferential portion 32 form the welded portion 20.

The valve 40 is seated on or separated from a valve contact surface 38 of the valve seat 12 joined to the opening circumferential portion 32 of the cylinder head main body 16, whereby each of the ports can be opened and closed. Moreover, between the intake port 28 and the exhaust port 30 of the cylinder head main body 16, a cooling jacket 42 that circulates cooling water is provided, and, by transferring the heat of the valve 40 to the cooling jacket 42 via the valve seat 12 and the cylinder head main body 16, it is possible to cool the valve 40 and so forth satisfactorily.

Next, with reference to FIGS. 1 to 3, the welded portion forming structure 10 for forming the above-described welded portion 20 will be described. That is, the valve seat 12 and the cylinder head main body 16 before the formation of the welded portion 20 will be described. The opening circumferential portion 32 and the valve seat 12 depicted in FIG. 1 are disposed in such a way that the axial directions (arrow X1-X2 directions) thereof coincide with each other and the radial directions (arrow Y directions) thereof are parallel to each other. Moreover, the valve seat 12 is inserted into the opening circumferential portion 32 from one end side (the arrow X1 side, hereinafter also referred to simply as “the one end side”) to the other end side (the arrow X2 side, hereinafter also referred to simply as “the other end side”) of the opening circumferential portion 32 in the axial direction.

In the following description, as for the valve seat 12, a front end side (the arrow X2 side) and a base end side (the arrow X1 side) in an insertion direction (the arrow X2 direction) in which the valve seat 12 is inserted into the opening circumferential portion 32 are also referred to simply as the front end side and the base end side, respectively. Moreover, the outer side and the center side of each of the valve seat 12 and the opening circumferential portion 32 in the radial direction (the arrow Y direction) are also referred to simply as the outer side and the center side, respectively.

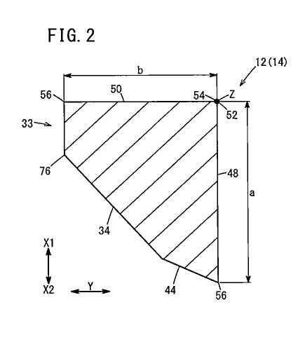

As depicted in FIGS. 1 and 2, a front end face 44 of the valve seat 12 has a taper shape whose diameter is increased from the front end side to the base end side. In the outer periphery 33 of the valve seat 12, a first joint surface 34 having a taper shape whose diameter is increased from the front end side to the base end side is provided. An inner periphery 48 of the valve seat 12 extends in the axial direction, and a base end face 50 of the valve seat 12 extends in the radial direction of the valve seat 12.

As depicted in FIG. 2, a direction in which the inner periphery 48 of the valve seat 12 extends and a direction in which the base end face 50 of the valve seat 12 extends intersect at an intersection Z. In the present embodiment, the intersection Z coincides with both an end 52 of the inner periphery 48 of the valve seat 12 on the base end side and an end 54 of the base end face 50 on the center side.

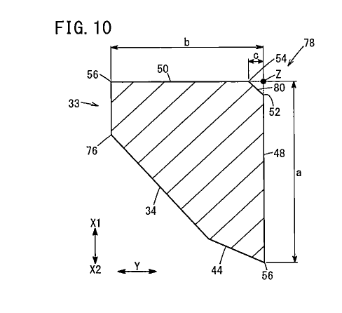

In the valve seat 12, if the distance between an end 56 of the inner periphery 48 on the front end side and the intersection Z is assumed to be a, the distance between an end 56 of the base end face 50 on the outer side and the intersection Z is assumed to be b, and the distance between the end 54 of the base end face 50 on the center side and the intersection Z is assumed to be c (see FIG. 10), a relation that satisfies all of b/a≥1 and b/3≥c≥0 holds. In the present embodiment, the end 54 of the base end face 50 on the center side and the intersection Z coincide with each other as described above, and therefore c=0.

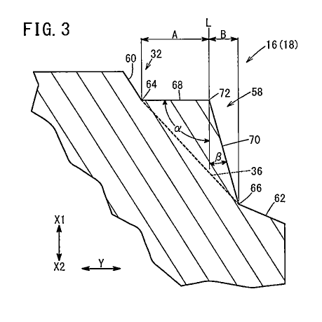

As depicted in FIGS. 1 and 3, the inner periphery of the opening circumferential portion 32 has a convex portion 58, a first tapered surface 60, and a second tapered surface 62. The convex portion 58 protrudes in an annular ring shape from the second joint surface 36 which, as described earlier, can form the welded portion 20 (see FIG. 4) with the first joint surface 34 of the valve seat 12. The first tapered surface 60 has a taper shape extending from a first origin portion 64 of the second joint surface 36 from which the convex portion 58 rises on the one end side, to the one end side in the axial direction, in a direction in which the diameter of the opening circumferential portion 32 is increased. The second tapered surface 62 has a taper shape extending from a second origin portion 66 of the second joint surface 36 from which the convex portion 58 rises on the other end side, to the other end side in the axial direction, in a direction in which the diameter of the opening circumferential portion 32 is reduced.

As depicted in FIG. 3, the convex portion 58 has a first surface 68 extending from the first origin portion 64 to the center side of the opening circumferential portion 32 in the radial direction, and a second surface 70 which extends from the second origin portion 66 to the end of extension of the first surface 68 and forms a corner with the first surface 68. If the distance in the radial direction between a vertex 72 of the corner and the first origin portion 64 is assumed to be A and the distance in the radial direction between the vertex 72 and the second origin portion 66 is assumed to be B, then a relation that satisfies all of A>0, A≥B, and B≥0 holds. Moreover, in the interior angle of the corner, if an angle formed by the first surface 68 and a reference line L which passes through the vertex 72 in parallel with the axial direction of the opening circumferential portion 32 is assumed to be α, and an angle formed by the reference line L and the second surface 70 is assumed to be β, then a relation that satisfies all of α>0, α≥β, and β≥0 holds.

As depicted in FIG. 1, as for the valve seat 12 and the opening circumferential portion 32, if an angle which the first joint surface 34 forms with the axial direction of the valve seat 12 is assumed to be θ1, and an angle which the second joint surface 36, which connects the first origin portion 64 and the second origin portion 66 in the shortest distance, forms with the axial direction of the opening circumferential portion 32 is assumed to be θ2, settings are made so that θ1 and θ2 are equal. The above settings to make θ1 and θ2 equal also include a case where θ1 and θ2 are made to be substantially equal.

The shapes of the front end face 44 of the valve seat 12 and the second tapered surface 62 of the opening circumferential portion 32 are set, by, for example, making the taper angles thereof substantially equal, so that the valve seat 12 and the cylinder head main body 16 have a desired joining position relationship when the front end face 44 and the second tapered surface 62 come into contact with each other.

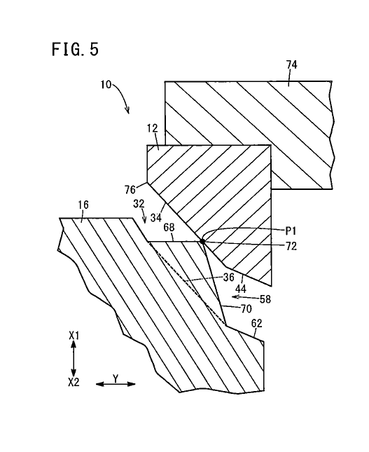

Next, with reference also to FIGS. 5 to 8, the joining method of joining the valve seat 12 and the cylinder head main body 16 by forming the welded portion 20 from the above-described welded portion forming structure 10 will be described.

In this joining method, first, as depicted in FIG. 5, the valve seat 12 and the cylinder head main body 16 are set between a pair of electrodes: an electrode 74 and an unillustrated electrode. In so doing, the front end face 44 of the valve seat 12 and the second tapered surface 62 of the opening circumferential portion 32 are made to face toward each other with a space left therebetween and the vertex 72 of the convex portion 58 is brought into contact with the first joint surface 34. When the first joint surface 34 and the vertex 72 are thus in line contact, the position of contact in the radial direction of the opening circumferential portion 32 is assumed to be P1.

The pair of electrodes is connected to a power supply via a capacitor, for example, and can be driven in directions in which the electrodes get close to or move away from each other by a driving mechanism such as a pressure cylinder (none of which is illustrated). Thus, by driving this pair of electrodes in directions in which the electrodes get close to each other, it is possible to apply welding pressure (a pressure welding load) to the valve seat 12 and the cylinder head main body 16 in directions in which the valve seat 12 and the cylinder head main body 16 get close to each other. By energizing the valve seat 12 and the cylinder head main body 16 while applying the pressure welding load thereto in this manner, it is possible to start resistance welding.

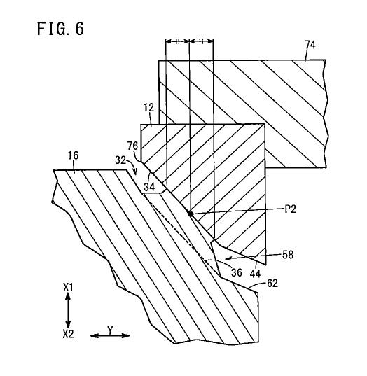

That is, the region of contact between the valve seat 12 and the cylinder head main body 16 generates heat based on contact resistance. As a result, when the temperature reaches the melting point of the cylinder head main body 16 (the convex portion 58), the convex portion 58 begins to melt. Consequently, as depicted in FIG. 6, it is possible to bring the valve seat 12 and the cylinder head main body 16 close to each other while discharging the melted convex portion 58 from between the first joint surface 34 and the second joint surface 36. At this time, the melted convex portion 58 and the first joint surface 34 make surface contact with each other. The center P2 of the contact surface between the valve seat 12 and the cylinder head main body 16 in the radial direction (hereinafter also referred to simply as a contact surface center) is placed on a side closer to the outer side in the radial direction than the contact position P1 observed at the beginning of contact.

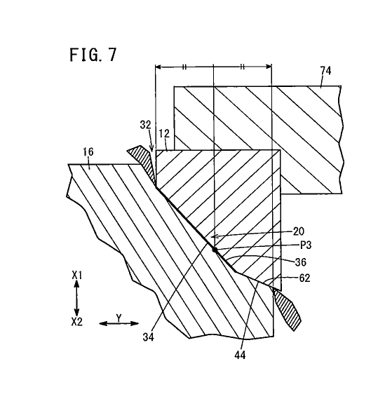

As depicted in FIG. 7, when almost the entire convex portion 58 melts away, the first joint surface 34 and the second joint surface 36 make contact with each other, which results in the formation of the welded portion 20, and the front end face 44 and the second tapered surface 62 come into contact with each other. The contact surface center P3 between the valve seat 12 and the cylinder head main body 16 at this time is placed on a side closer to the center side in the radial direction than the contact surface center P2.

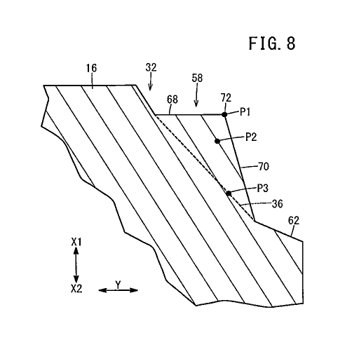

That is, as depicted in the explanatory diagram of FIG. 8, even when resistance welding is conducted concurrently with melting of the convex portion 58, the contact surface center P2 is avoided from shifting to a side closer to the center side in the radial direction than the contact position P1 until the first joint surface 34 and the second joint surface 36 make contact with each other.

Moreover, when the front end face 44 and the second tapered surface 62 come into contact with each other, the contact area between the valve seat 12 and the cylinder head main body 16 increases rapidly compared to when only the first joint surface 34 and the convex portion 58 are in contact with each other. As a result, the value of current per unit area which flows between the valve seat 12 and the cylinder head main body 16 is decreased (contact resistance is reduced). This reduces the amount of heat generation in the contact surface between the valve seat 12 and the cylinder head main body 16. As a result, it becomes impossible to obtain the amount of heat required to melt the cylinder head main body 16, and melting of the cylinder head main body 16 is temporarily stopped.

Therefore, by stopping the energization immediately before the front end face 44 and the second tapered surface 62 come in contact, or at the same time as the contact is made, it is possible to avoid further melting of the cylinder head main body 16, in other words, to avoid melting of the second tapered surface 62. This makes it possible to finish the resistance welding in a state in which the front end face 44 and the second tapered surface 62 are in contact with each other.

As mentioned earlier, the shapes of the front end face 44 and the second tapered surface 62 are set so that the valve seat 12 and the cylinder head main body 16 have a desired positional relationship when the front end face 44 and the second tapered surface 62 come into contact with each other. As a result, by forming the welded portion 20 in the above-described manner, it is possible to join the valve seat 12 and the cylinder head main body 16 in a desired positional relationship. Then, the valve contact surface 38 is formed by performing machining on the valve seat 12, whereby the cylinder head 22 is obtained (see FIG. 4). That is, in this cylinder head 22, the welded portion 20 is formed by the first joint surface 34 and the second joint surface 36 and the area between the front end face 44 and the second tapered surface 62 is an unmelted area in which the front end face 44 and the second tapered surface 62 are just in contact with each other.

Next, the workings and effects of the welded portion forming structure 10 and the joining method according to the first embodiment will be described. In the welded portion forming structure 10, as described earlier, since the convex portion 58 is provided in the second joint surface 36 of the opening circumferential portion 32, resistance welding can be started in a state in which the vertex 72 of the convex portion 58 is in line contact with the first joint surface 34. As a result, even when the shapes of the valve seat 12 and the cylinder head main body 16 vary, it is possible to prevent variations in the contact area between the valve seat 12 and the cylinder head main body 16 at the beginning of contact.

Moreover, in the welded portion forming structure 10, the shape of the convex portion 58 is set so that a relation that satisfies all of A>0, A≥B, and B≥0 or a relation that satisfies all of α>0, α≥β, and β≥0 holds and the shapes of the valve seat 12 and the cylinder head main body 16 are set so that θ1 and θ2 are equal. As a result, as described earlier, even when resistance welding is conducted concurrently with melting of the convex portion 58, the contact surface center P2 can be avoided from shifting to a side closer to the center side in the radial direction than the contact position P1 until the first joint surface 34 and the second joint surface 36 come in contact with each other. Consequently, it is possible to effectively prevent the valve seat 12 from being deformed by the pressure welding load during the resistance welding.

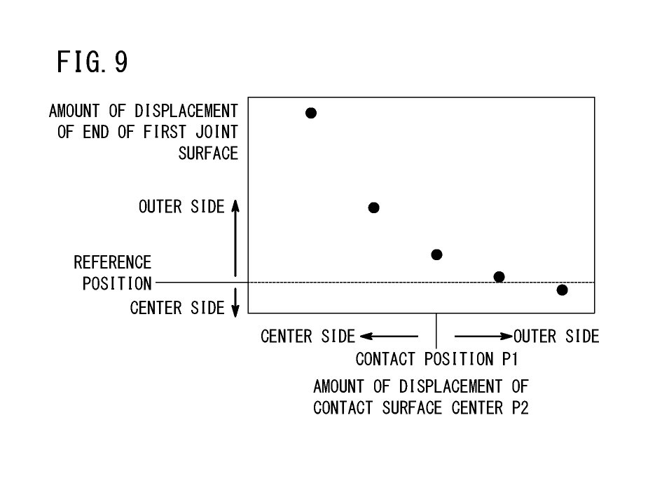

This is also clear from the graph shown in FIG. 9. The horizontal axis of this graph represents the amount of displacement of the contact surface center P2 with respect to the contact position P1 in the radial direction. Moreover, the vertical axis of this graph represents the amount of displacement of an end 76 (see FIGS. 2 and 5, for example) of the first joint surface 34 on the base end side with respect to a reference position in the radial direction. The reference position is the position of the end 76 in the radial direction at the beginning of contact between the first joint surface 34 and the vertex 72 (see FIG. 5). That is, the value on the vertical axis indicates the amount of deformation of the first joint surface 34 of the valve seat 12 caused by the pressure welding load.

It is clear from FIG. 9 that the closer to the center side in the radial direction the contact surface center P2 shifts, the more greatly the end 76 of the first joint surface 34 is displaced to the outer side in the radial direction, that is, the more greatly the base end side of the valve seat 12 bends to the outer side in the radial direction. On the other hand, the amount by which the end 76 of the first joint surface 34 is displaced to the center side in the radial direction when the contact surface center P2 shifts to the outer side in the radial direction is considerably smaller than the amount of displacement of the end 76 in the case where the contact surface center P2 shifts to the center side in the radial direction. That is, it is clear that the deformation of the valve seat 12 can be prevented by avoiding the contact surface center P2 from shifting to the center side in the radial direction.

Moreover, in the welded portion forming structure 10, the shape of the valve seat 12 is set so that a relation that satisfies all of b/a≥1 and b/3≥c≥0 holds. Since this makes it possible to increase the stiffness of the valve seat 12 against the pressure welding load satisfactorily, it is possible to more effectively prevent the valve seat 12 from being deformed during resistance welding.

As described so far, irrespective of whether or not the shapes of the valve seat 12 and the cylinder head main body 16 vary, it is possible to keep the valve seat 12 and the cylinder head main body 16 in good contact with each other from the beginning to the end of resistance welding. Since this makes it possible to prevent variations in the joint strength between the valve seat 12 and the cylinder head main body 16, it is possible to maintain good joint quality of the welded portion 20. As a result, it is possible to form the welded portion 20 of high joint strength.

For instance, in a structure that forms the welded portion 20 by overlaying the valve seat 12 on the second joint surface 36 by a laser cladding process, there are severe restrictions on materials which can be applied as the valve seat 12 and the cylinder head main body 16. However, in the welded portion forming structure 10, it is possible to use, as the valve seat 12 and the cylinder head main body 16, various materials on which resistance welding can be performed. As a result, as mentioned earlier, even when the valve seat 12 is formed of an iron-based material and the cylinder head main body 16 is formed of an aluminum-based material, it is possible to form the welded portion 20 satisfactorily. By using an iron-based material, it is possible to increase the wear resistance of the valve seat 12, for example, and, by using an aluminum-based material, it is possible to reduce the weight of the cylinder head main body 16, for example.

In the welded portion forming structure 10, it is possible to join the first joint surface 34 of the valve seat 12 and the second joint surface 36 of the cylinder head main body 16 by forming the welded portion 20 by resistance welding. As a result, unlike in a case where the valve seat 12 and the cylinder head main body 16 are joined by press fitting, shrinkage fit, or the like, it is possible to achieve sufficient joint strength in a small fixed space. That is, since the thickness of the valve seat 12 can be reduced, it is possible to enhance flexibility of the shapes of the ports and increase cooling efficiency of the valve 40 and so forth by shortening the distance between the valve contact surface 38 of the valve seat 12 and the cooling jacket 42 (see FIG. 4).

In the welded portion forming structure 10 according to the first embodiment, the valve seat 12 is not limited to the shape depicted in FIG. 2, and the shape thereof can be changed in various ways as long as θ1 is equal to θ2 (see FIG. 1). For example, like a valve seat 78 depicted in FIG. 10, a notch 80 may be formed on the base end side of the inner periphery 48 and the center side of the base end face 50. In this valve seat 78, unlike the above-described valve seat 12, the end 52 of the inner periphery 48 on the base end side is away from the intersection Z toward the front end side, and the end 54 of the base end face 50 on the center side is away from the intersection Z toward the outer side, and therefore c>0. Also in this case, it is preferable that a relation that satisfies all of b/a≥1 and b/3≥c>0 holds. As a result, as is the case in the above-described valve seat 12, this increases the stiffness of the valve seat 78 against pressure welding load satisfactorily, and it is possible to more effectively prevent the valve seat 78 from being deformed during resistance welding.

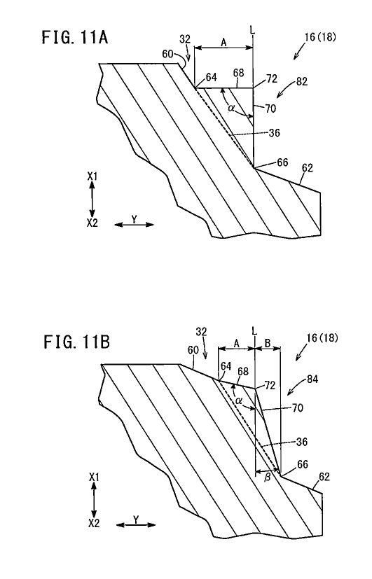

Furthermore, the convex portion 58 which is provided in the opening circumferential portion 32 of the cylinder head main body 16 is not limited to the shape depicted in FIG. 3, and the shape thereof can be changed in various ways as long as a relation that satisfies all of A>0, A≥B, and B≥0 or a relation that satisfies all of α>0, α≥β, and β≥0 holds. For instance, like a convex portion 82 depicted in FIG. 11A, settings may be made so that B=0. In this case, β=0 and α=90°. Moreover, like a convex portion 84 depicted in FIG. 11B, the first surface 68 may have a taper shape extending in a direction in which the diameter of the opening circumferential portion 32 is increased from the vertex 72 to the first origin portion 64.

Even when the convex portions 82 and 84 having the shapes depicted in FIGS. 11A and 11B are provided on the cylinder head main body 16, it is possible to obtain the same workings and effects as those of the case where the above-described convex portion 58 is provided. That is, even when the shapes of the valve seat 12 and the cylinder head main body 16 vary, it is possible to form the welded portion 20 of high joint strength.

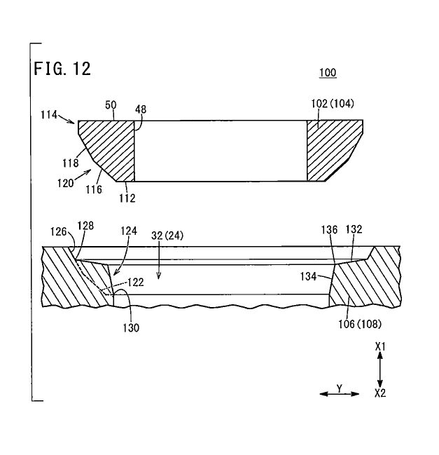

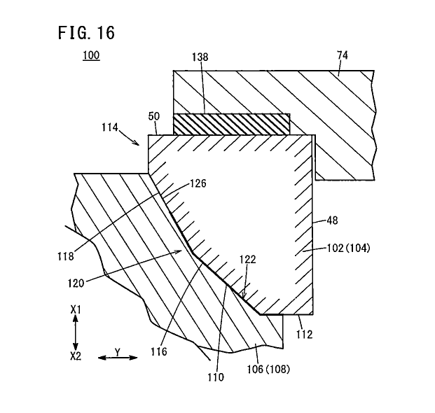

Next, with reference to FIGS. 12 to 16, a welded portion forming structure 100 according to a second embodiment will be described. As is the case in the first embodiment, also in the second embodiment, an example will be described in which the welded portion forming structure 100 is a structure for forming a welded portion 110 (see FIG. 16) that joins a first metal member 104 which is a valve seat 102 and a second metal member 108 which is a cylinder head main body 106, but the application is not particularly limited thereto.

That is, also by a joining method according to the second embodiment, a cylinder head (which is not depicted in the drawing) is obtained by joining the valve seat 102 and the cylinder head main body 106 by forming the welded portion 110 from the welded portion forming structure 100. Since this cylinder head is configured in the same manner as the above-described cylinder head 22 except that this cylinder head includes the valve seat 102, the cylinder head main body 106, and the welded portion 110 which are depicted in FIGS. 12 and 16, for example, in place of the valve seat 12, the cylinder head main body 16, and the welded portion 20, respectively, which are depicted in FIGS. 1 and 7, for example, detailed explanations thereof will be omitted.

The valve seat 102 is configured in the same manner as the valve seat 12 (see FIG. 1) except for the shapes of a front end face 112 and an outer periphery 114. The valve seat 102 may be configured in the same manner as the valve seat 78 (see FIG. 10) except for the shapes of the front end face 112 and the outer periphery 114.

The surface direction of the front end face 112 is parallel to the radial direction of the valve seat 102. In the outer periphery 114 of the valve seat 102, a first tapered-shaped portion 116 and a second tapered-shaped portion 118, whose surface directions are different from each other, are provided. Each of the first tapered-shaped portion 116 and the second tapered-shaped portion 118 has a taper shape whose diameter is increased from the front end side to the base end side. The first tapered-shaped portion 116 is placed on a side closer to the front end side than the second tapered-shaped portion 118, and the base end of the first tapered-shaped portion 116 and the front end of the second tapered-shaped portion 118 coincide with each other. The front end of the first tapered-shaped portion 116 coincides with the end of the front end face 112 on the outer side. As depicted in FIG. 16, in the valve seat 102, part of the front end face 112 on the outer side, the whole of the first tapered-shaped portion 116, and part of the second tapered-shaped portion 118 on the other end side (the arrow X2 side) form a first joint surface 120.

The shape of the outer periphery 114 of the valve seat 102 is not limited to the above-described shape. In place of the two first tapered-shaped portion 116 and second tapered-shaped portion 118 whose surface directions are different from each other, one tapered-shaped portion or three or more tapered-shaped portions may be provided. Moreover, the shape of the first joint surface 120 is not limited to the above-described shape, either. The first joint surface 120 is provided in at least part of the outer periphery 114 of the valve seat 102.

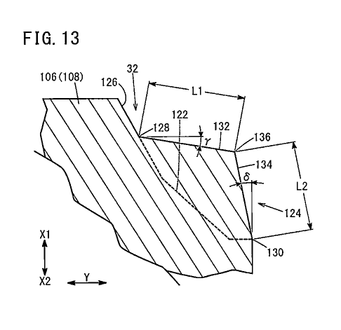

The cylinder head main body 106 is configured in the same manner as the cylinder head main body 16 except for the shape of the inner periphery of the opening circumferential portion 32. As depicted in FIGS. 12 and 13, in the cylinder head main body 106 which is not yet joined to the valve seat 102, the inner periphery of the opening circumferential portion 32 includes a convex portion 124 and a tapered surface 126. The convex portion 124 protrudes in an annular ring shape from a second joint surface 122 which can form the welded portion 110 (see FIG. 16) with the first joint surface 120 of the valve seat 102.

As depicted in FIG. 16, the second joint surface 122 has a shape that allows the second joint surface 122 to conform to the first joint surface 120 of the valve seat 102 when the welded portion 110 is formed. Moreover, in the cylinder head main body 106 according to the second embodiment, the area from the end of the second joint surface 122 on the center side in the radial direction to the other end side forms the inner periphery of the port.

As depicted in FIG. 13, the tapered surface 126 has a taper shape extending from a first origin portion 128 of the second joint surface 122 from which the convex portion 124 rises on the one end side (the arrow X1 side), further to the one end side, in a direction in which the diameter of the opening circumferential portion 32 is increased. Moreover, as depicted in FIG. 16, the shapes of the tapered surface 126 and the second tapered-shaped portion 118 of the valve seat 102 are set, by, for example, making the taper angles thereof substantially equal, so that the valve seat 102 and the cylinder head main body 106 have a desired joining position relationship when the tapered surface 126 and the second tapered-shaped portion 118 come into contact with each other. As depicted in FIG. 13, a second origin portion 130 of the second joint surface 122 from which the convex portion 124 rises on the other end side, coincides with the end of the second joint surface 122 on the center side.

The convex portion 124 has a first surface 132 extending from the first origin portion 128 to the center side and a second surface 134 which extends from the second origin portion 130 to the end of extension of the first surface 132 and forms a corner with the first surface 132. If the length of the first surface 132 from the first origin portion 128 to a vertex 136 of the corner is assumed to be L1 and the length of the second surface 134 from the second origin portion 130 to the vertex 136 is assumed to be L2 in a cross section of the opening circumferential portion 32 (the insertion opening 24) in the axial direction, a relation of 0.7×L2≤L1≤1.3×L2 holds. L1 and L2 may be substantially equal.

As will be described later, when the welded portion 110 is formed by resistance welding, since the distance between the welded portion 110 and the electrode 74 is shorter on the outer side of the cylinder head main body 106 than on the center side, current tends to be concentrated and more heat is generated on the outer side of the cylinder head main body 106. For this reason, to make the whole of the cylinder head main body 106 generate heat more evenly during resistance welding, it is preferable to make L2 slightly smaller than L1.

Moreover, in the convex portion 124, if an angle formed by the radial direction of the opening circumferential portion 32 and the surface direction of the first surface 132 is assumed to be γ and an angle formed by the axial direction of the opening circumferential portion 32 and the surface direction of the second surface 134 is assumed to be β, it is preferable that settings are made so that a relation of 0°<γ=δ<45° holds.

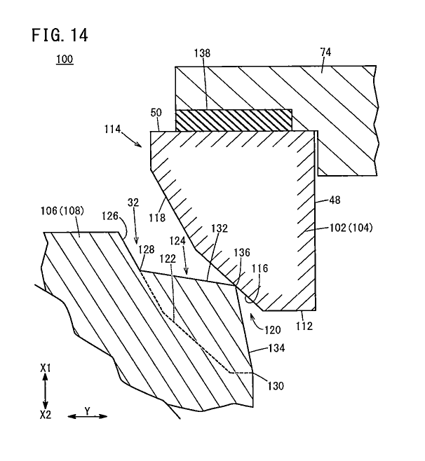

Next, the joining method of joining the valve seat 102 and the cylinder head main body 106 by forming the welded portion 110 from the above-described welded portion forming structure 100 will be described. In this joining method, first, as depicted in FIG. 14, the valve seat 102 and the cylinder head main body 106 are set between a pair of electrodes: the electrode 74 and the unillustrated electrode. In so doing, the second tapered-shaped portion 118 of the valve seat 102 and the tapered surface 126 of the opening circumferential portion 32 are made to face toward each other with a space left therebetween and the vertex 136 of the convex portion 124 is brought into contact with the first tapered-shaped portion 116.

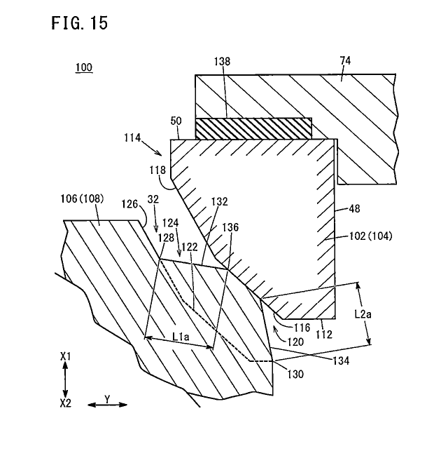

Next, resistance welding is started by energizing the valve seat 102 and the cylinder head main body 106 while applying a pressure welding load thereto by driving the pair of electrodes in directions in which the electrodes get close to each other. As a result, the region of contact between the valve seat 102 and the cylinder head main body 106 generates heat based on contact resistance, and the convex portion 124 begins to melt. Then, the valve seat 102 and the cylinder head main body 106 are brought closer to each other while discharging the melted convex portion 124 from between the first joint surface 120 and the second joint surface 122, and, as depicted in FIG. 15, the melted convex portion 124 and the first tapered-shaped portion 116 of the first joint surface 120 come in surface contact with each other.

In so doing, since the relationship between L1 and L2 is set as described above, it is possible to conduct the resistance welding while keeping substantially equal the length L1a of the remaining unmelted portion of the first surface 132 and the length L2a of the remaining unmelted portion of the second surface 134. The length L1a is the length of the remaining first surface 132 from the first origin portion 128 to the end on the center side in a cross section of the opening circumferential portion 32 in the axial direction. The length L2a is the length of the remaining second surface 134 from the second origin portion 130 to the end on the one end side in a cross section of the opening circumferential portion 32 in the axial direction.

In particular, in the cross section of the opening circumferential portion 32 in the axial direction, it is preferable that the angle formed by a surface connecting the first origin portion 128 of the first surface 132 and the second origin portion 130 of the second surface 134 and the axial direction of the opening circumferential portion 32, and the angle formed by the first tapered-shaped portion 116 of the valve seat 102 and the axial direction of the opening circumferential portion 32 are substantially equal.

When almost the entire convex portion 124 melts away, as depicted in FIG. 16, the first joint surface 120 and the second joint surface 122 make contact with each other, whereby the welded portion 110 is formed, and a part of the second tapered-shaped portion 118 closer to the one end side than the first joint surface 120, and a part of the tapered surface 126 closer to the one end side than the second joint surface 122, come into contact with each other. At this time, the resistance welding is terminated by stopping the energization immediately before, or at the same time as, contact is made between the part of the second tapered-shaped portion 118 closer to the one end side than the first joint surface 120 and the part of the tapered surface 126 closer to the one end side than the second joint surface 122.

As a result, it is possible to join the valve seat 102 and the cylinder head main body 106 in a desired positional relationship. Then, the valve contact surface 38 (see FIG. 4) is formed by performing machining on the valve seat 102, whereby the cylinder head is obtained. That is, in this cylinder head, the welded portion 110 is formed by the first joint surface 120 and the second joint surface 122. Moreover, an area between the part of the second tapered-shaped portion 118 closer to the one end side than the first joint surface 120, and the part of the tapered surface 126 closer to the one end side than the second joint surface 122, is an unmelted area in which the part of the second tapered-shaped portion 118 and the part of the tapered surface 126 are just in contact with each other.

Next, the workings and effects of the welded portion forming structure 100 and the joining method according to the second embodiment will be described. Also in the welded portion forming structure 100, as is the case in the welded portion forming structure 10 according to the first embodiment, since the convex portion 124 is provided in the second joint surface 122 of the opening circumferential portion 32, it is possible to start resistance welding in a state in which the vertex 136 of the convex portion 124 is in line contact with the first joint surface 120. As a result, even when the shapes of the valve seat 102 and the cylinder head main body 106 vary, it is possible to prevent variations in the contact area between the valve seat 102 and the cylinder head main body 106 at the beginning of contact.

Moreover, in the welded portion forming structure 100, the shape of the convex portion 124 is set so that L1 and L2 are substantially equal, and it is possible to conduct resistance welding while maintaining the relationship that L1a and L2a are substantially equal. As a result, since it is possible to prevent the length (the energization distance) of the path of current flowing through the convex portion 124 during resistance welding from varying from part to part of the convex portion 124, it is possible to prevent a temperature difference from being generated in the contact surface between the valve seat 102 and the cylinder head main body 106 (the melted convex portion 124).

In particular, it is preferable that an insulating portion 138 is provided in the electrode 74 around the outer edge of its surface facing the base end face 50 of the valve seat 102. The insulating portion 138 is formed of a void or an insulating material provided in the electrode 74 and provides partial insulation between the electrode 74 and the valve seat 102. Thus providing the insulating portion 138 in the electrode 74 makes it possible to maintain the relationship by which the length of the path of current is kept equal over the entire energization time of resistance welding.

Thus, with this welded portion forming structure 100, irrespective of whether or not, for example, the shapes of the valve seat 102 and the cylinder head main body 106 vary, it is possible to heat the contact surface between the valve seat 102 and the cylinder head main body 106 substantially evenly from the beginning to the end of resistance welding. This makes it possible to prevent variations in the joint strength between the valve seat 102 and the cylinder head main body 106 and maintain good joint quality by the welded portion 110. In other words, it is possible to form the welded portion 110 that can join the valve seat 102 and the cylinder head main body 106 satisfactorily.

Moreover, in the welded portion forming structure 100 according to the second embodiment, the shape of the convex portion 124 is set so that the relation of 0°<γ=δ<45° holds. In this case, it is possible to reduce the amount of the melted convex portion 124 which is discharged from between the first joint surface 120 and the second joint surface 122 during resistance welding. This makes it possible to reduce energy required to form the welded portion 110. The shape of the convex portion 124 is not limited to the shape that makes the relation of 0°<γ=δ<45° hold; for example, the values of γ and δ may be different from each other. Furthermore, each of γ and δ may be 0° or may be 45° or more.

The present invention is not particularly limited to the embodiments described above and various modifications can be made thereto within the scope of the present invention.

For instance, the convex portions 58, 82, 84 of the welded portion forming structure 10 according to the above-described first embodiment may also have shapes that make a relation corresponding to 0°<γ=δ<45° hold as is the case in the convex portion 124 of the welded portion forming structure 100 according to the above-described second embodiment.

### EXAMPLES

### Example 1

As depicted in FIG. 11A, the shape of the convex portion 82 was set so that α>β and β=0. That is, in this convex portion 82, a relation that satisfies all of α>0, α≥0, and β≥0 holds.

Moreover, the shape of the valve seat 78 was set so that a relation of a=5.00, b=5.35, and c=0.20 holds. That is, in this valve seat 78, b/a=1.07 and c=b/26.75 and a relation that satisfies all of b/a≥1 and b/3≥c≥0 holds.

By applying the above-described joining method to these convex portion 82 and valve seat 78, the welded portion 20 was formed between the first joint surface 34 and the second joint surface 36. At this time, by conducting a displacement amount measurement test, the amount of displacement of the valve seat 78 caused by the pressure welding load was obtained. Moreover, by conducting a joint strength measurement test, the joint strength achieved by the welded portion 20 was obtained.

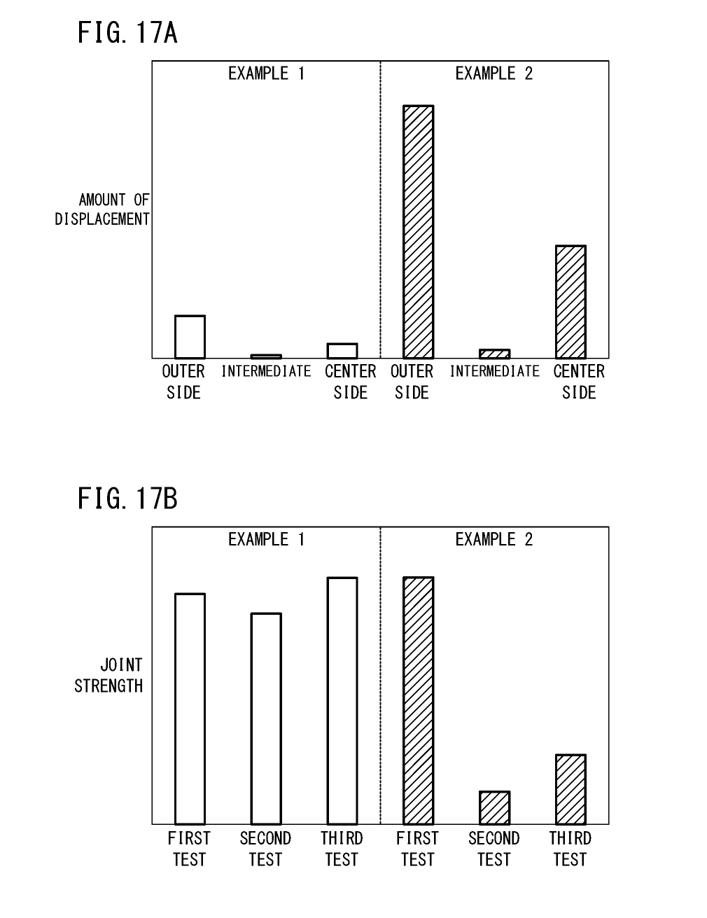

Specifically, the displacement amount measurement test was conducted on the first joint surface 34 in cases where a load center point was generated in three places: the outer side and the center side in the radial direction of the surface of the valve seat 78 to which pressure welding load was applied from the electrode 74, and an intermediate part therebetween. For each of these load center points, the amount by which the first joint surface 34 was displaced from the beginning of contact between the vertex 72 of the convex portion 82 and the first joint surface 34 was considered as the amount of displacement of the valve seat 78. The results of the displacement amount measurement test conducted on each of these places are shown in FIG. 17A as

### Example 1

Moreover, in the joint strength measurement test, the torque applied to the valve seat 78 was gradually increased with the cylinder head main body 16 being fixed, and the magnitude of torque observed when the second joint surface 36 and the first joint surface 34 separated off from each other was obtained as joint strength. The results of this joint strength measurement test conducted three times are shown in FIG. 17B as Example 1.

### Example 2

The results of the displacement amount measurement test and the results of the joint strength measurement test are shown in FIGS. 17A and 17B, respectively, as Example 2, the tests conducted in the same manner as Example 1 except that the shape of the valve seat 78 was set so as to make a relation of a=5.00, b=5.35, and c=2.00 hold. In this valve seat 78, since b/a=1.07 and c=b/2.67, although b/a≥1 is satisfied, b/3≥c≥0 is not satisfied.

It is clear from FIG. 17A that, in Example 1, compared to Example 2, the amount of displacement which was obtained by the displacement amount measurement test can be stably reduced in the radial direction of the valve seat 78 in its entirety. Moreover, it is clear from FIG. 17B that, in Example 1, compared to Example 2, the joint strengths obtained by the three joint strength measurement tests exhibit a narrow range of variation and joint strength can be stably increased.

### Example 3

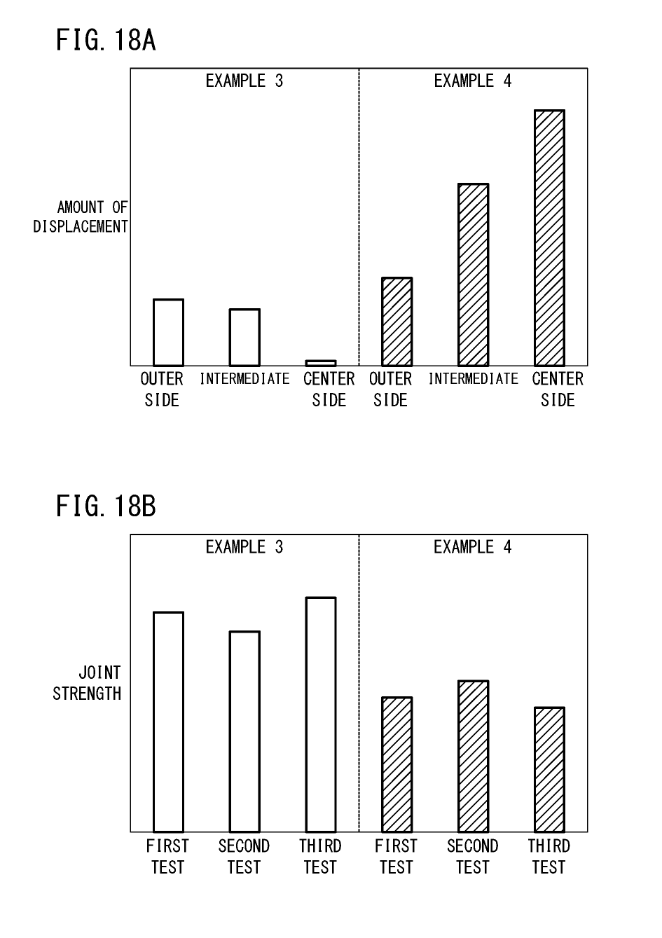

The results of the displacement amount measurement test and the results of the joint strength measurement test are shown in FIGS. 18A and 18B, respectively, as Example 3, the tests conducted in the same manner as Example 1 on the valve seat 78 and the convex portion 82 whose shapes were set in the same manner as Example 1.

### Example 4

The results of the displacement amount measurement test and the results of the joint strength measurement test are shown in FIGS. 18A and 18B, respectively, as Example 4, the tests conducted in the same manner as Example 1 except that the shape of the valve seat 78 was set so as to make a relation of a=5.20, b=3.97, and c=0.20 hold. In this valve seat 78, since b/a=0.76 and c=b/19.85, although b/3≥c≥0 is satisfied, b/a≥1 is not satisfied.

It is clear from FIG. 18A that, in Example 3, compared to Example 4, the amount of displacement obtained by the displacement amount measurement test can be stably reduced in the radial direction of the valve seat 78 in its entirety. Moreover, it is clear from FIG. 18B that, in Example 3, compared to Example 4, the joint strengths obtained by the three joint strength measurement tests exhibit a narrow range of variation and joint strength can be increased as a whole.

Examples 1 to 4 described above reveal that shaping the valve seat 78 so that a relation that satisfies all of b/a≥1 and b/3≥c≥0 hold more effectively prevents the valve seat 78 from being deformed by the pressure welding load. As a result, since resistance welding can be performed with the valve seat 78 and the cylinder head main body 16 being in good contact with each other, it is possible to improve the joint quality which is obtained by the welded portion 20.

### Example 5

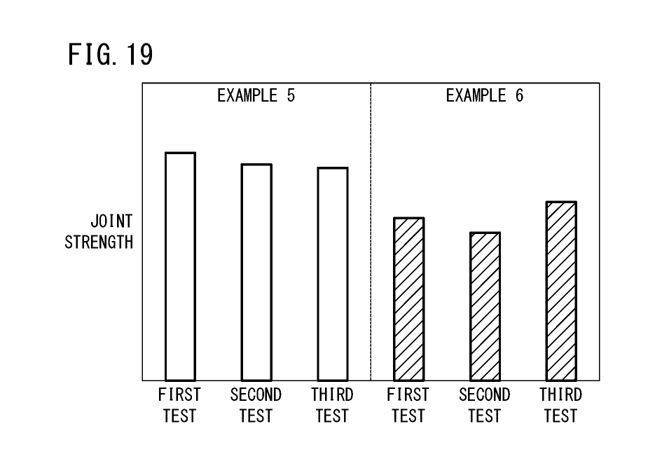

The shape of the convex portion 124 depicted in FIG. 13 was set so that L2 was slightly smaller than L1 (L1≥L2) by setting L1=1.28×L2. The results of the joint strength measurement tests conducted on this convex portion 124 and the valve seat 102 depicted in FIG. 12 in the same manner as Example 1 are shown in FIG. 19 as Example 5.

### Example 6

The shape of the convex portion 124 was set so that L2 was slightly greater than L1 (L1<L2) by setting L1=(0.738 to 0.952)×L2. The results of the joint strength measurement tests conducted on this convex portion 124 and the valve seat 102 depicted in FIG. 12 in the same manner as Example 1 are shown in FIG. 19 as Example 6.

It is clear from FIG. 19 that, in both Examples 5 and 6, good joint strength can be obtained. Moreover, it is clear that, in Example 5, compared to Example 6, the joint strengths obtained by the three joint strength measurement tests exhibit a narrow range of variation and joint strength can be more stably increased. Therefore, making L2 slightly smaller than L1 in the convex portion 124 within the range of 0.7×L2≤L1≤1.3×L2 makes it possible to perform resistance welding while heating the contact surface between the valve seat 102 and the cylinder head main body 106 more evenly and thereby more effectively improve the joint quality which is obtained by the welded portion 20.

1. A welded portion forming structure for forming a welded portion that joins a first metal member shaped like an annular ring and a second metal member having an insertion opening into which the first metal member is inserted, wherein
the first metal member is inserted into the insertion opening from one end side to another end side thereof in an axial direction, and an outer periphery of the first metal member has a first joint surface having a taper shape whose diameter is increased from a front end side to a base end side of an insertion direction into the insertion opening,
an inner periphery of the insertion opening has a convex portion, a first tapered surface, and a second tapered surface, the convex portion being shaped like an annular ring and protruding from a second joint surface which can form the welded portion with the first joint surface, the first tapered surface having a taper shape extending from a first origin portion of the second joint surface from which the convex portion rises on the one end side, to the one end side of the insertion opening, in a direction in which a diameter of the insertion opening is increased, the second tapered surface having a taper shape extending from a second origin portion of the second joint surface from which the convex portion rises on the other end side, to the other end side of the insertion opening, in a direction in which the diameter of the insertion opening is reduced,
the convex portion has a first surface extending from the first origin portion to a center side of the insertion opening in a radial direction, and a second surface which extends from the second origin portion to an end of extension of the first surface and forms a corner with the first surface,
if a distance in the radial direction between a vertex of the corner and the first origin portion is assumed to be A, and a distance in the radial direction between the vertex and the second origin portion is assumed to be B, then a relation that satisfies all of A>0, A≥B, and B≥0 holds, and
an angle which the first joint surface forms with an axial direction of the first metal member, and an angle which the second joint surface connecting the first origin portion and the second origin portion in a shortest distance forms with the axial direction of the insertion opening are equal.

2. The welded portion forming structure according to claim 1, wherein
in an interior angle of the corner, if an angle formed by a reference line, which passes through the vertex of the corner in parallel with the axial direction of the insertion opening, and the first surface is assumed to be α, and an angle formed by the reference line and the second surface is assumed to be β, then a relation that satisfies all of α>0, α≥β, and β≥0 holds.

3. A welded portion forming structure for forming a welded portion that joins a first metal member shaped like an annular ring and a second metal member having an insertion opening into which the first metal member is inserted, wherein
the first metal member is inserted into the insertion opening from one end side to another end side thereof in an axial direction, and an outer periphery of the first metal member has a first joint surface with a part having a taper shape whose diameter is increased from a front end side to a base end side of an insertion direction into the insertion opening,
an inner periphery of the insertion opening has a convex portion that is shaped like an annular ring and protrudes from a second joint surface which can form the welded portion with the first joint surface,
the convex portion has a first surface extending from a first origin portion of the second joint surface from which the convex portion rises on the one end side, to a center side of the insertion opening in a radial direction, and a second surface which extends from a second origin portion of the second joint surface from which the convex portion rises on the other end side, to an extension end of the first surface, and forms a corner with the first surface, and
if a length of the first surface from the first origin portion to a vertex of the corner is assumed to be L1 and a length of the second surface from the second origin portion to the vertex is assumed to be L2 in a cross section along an axis of the insertion opening, a relation of 0.7×L2≤L1≤1.3×L2 holds.

4. The welded portion forming structure according to claim 3, wherein the L1 and the L2 are substantially equal.

5. The welded portion forming structure according to claim 1, wherein, if an angle formed by the radial direction of the insertion opening and a surface direction of the first surface is assumed to be γ, and an angle formed by the axial direction of the insertion opening and a surface direction of the second surface is assumed to be δ, then a relation of 0°<γ=δ<45° holds.

6. The welded portion forming structure according to claim 1, wherein
a direction in which an inner periphery of the first metal member extends in the axial direction of the first metal member, and a direction in which a base end face, which is an end face of the first metal member on the base end side, extends in a radial direction of the first metal member intersect at an intersection,
an end of the inner periphery of the first metal member on the base end side coincides with the intersection or is away from the intersection to the front end side of the first metal member,
an end of the base end face on a center side of the first metal member in the radial direction coincides with the intersection or is away from the intersection to an outer side of the first metal member in the radial direction, and
if a distance between an end of the inner periphery of the first metal member on the front end side and the intersection is assumed to be a, a distance between an end of the base end face on the outer side of the first metal member in the radial direction and the intersection is assumed to be b, and a distance between the end of the base end face on the center side of the first metal member in the radial direction and the intersection is assumed to be c, then a relation that satisfies all of b/a≥1 and b/3≥c≥0 holds.

7. The welded portion forming structure according to claim 1, wherein the first metal member is formed of an iron-based material and the second metal member is formed of an aluminum-based material.

8. The welded portion forming structure according to claim 1, wherein
the first metal member is a valve seat,
the second metal member is a cylinder head main body, and
the insertion opening is an opening circumferential portion of a port provided in the cylinder head main body.

9. A metal member joining method of joining a first metal member shaped like an annular ring and a second metal member having an insertion opening into which the first metal member is inserted, by forming a welded portion from a welded portion forming structure, wherein
the first metal member is inserted into the insertion opening from one end side to another end side thereof in an axial direction, and an outer periphery of the first metal member has a first joint surface having a taper shape whose diameter is increased from a front end side to a base end side of an insertion direction into the insertion opening,
an inner periphery of the insertion opening has a convex portion, a first tapered surface, and a second tapered surface, the convex portion being shaped like an annular ring and protruding from a second joint surface which can form the welded portion with the first joint surface, the first tapered surface having a taper shape extending from a first origin portion of the second joint surface from which the convex portion rises on the one end side, to the one end side of the insertion opening, in a direction in which a diameter of the insertion opening is increased, the second tapered surface having a taper shape extending from a second origin portion of the second joint surface from which the convex portion rises on the other end side, to the other end side of the insertion opening, in a direction in which the diameter of the insertion opening is reduced,
the convex portion has a first surface extending from the first origin portion to a center side of the insertion opening in a radial direction, and a second surface which extends from the second origin portion to an end of extension of the first surface and forms a corner with the first surface,
if a distance in the radial direction between a vertex of the corner and the first origin portion is assumed to be A, and a distance in the radial direction between the vertex and the second origin portion is assumed to be B, then a relation that satisfies all of A>0, A≥B, and B≥0 holds,
an angle which the first joint surface forms with an axial direction of the first metal member, and an angle which the second joint surface connecting the first origin portion and the second origin portion in a shortest distance forms with the axial direction of the insertion opening are equal, and
the metal member joining method includes
a step of bringing the vertex of the corner into contact with the first joint surface; and
a step of energizing the first metal member and the second metal member while applying a pressure welding load thereto, so as to bring the first metal member and the second metal member closer to each other while discharging the convex portion, which is melted, from between the first joint surface and the second joint surface, and thus making the first joint surface and the second joint surface make contact with each other.
